(19) United States
(12) Patent Application Publication
(10) Pub. No.: US 2008/0197005 A1
(43) Pub. Date: Aug. 21, 2008

(54) Ultra-thin keypad

(75) Inventors: Jun-Lin Bu, Nanking City (CN); Guan-Feng Huang, Nanking City (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 12/010,189

(22) Filed: Jan. 22, 2008

(30) Foreign Application Priority Data
Feb. 16, 2007 (TW) 096203167

(51) Int. Cl. H01H 13/14

(52) U.S. Cl. 200/341

(57) ABSTRACT

The invention discloses an ultra-thin keypad for cooperating with a circuit board in a portable electronic device. The circuit board includes a plurality of switches. The ultra-thin keypad includes a main body, a plurality of buttons, and a plurality of thin walls. The buttons are disposed on the main body, and each of the buttons corresponds to one of the switches. The thin walls are disposed between adjacent ones of the buttons. When one of the buttons is pressed, the button contacts and activates the corresponding switch by the elastic deformation of the thin walls. The main body, the buttons, and the thin walls are manufactured integrally by injection molding.

### BACKGROUND OF THE INVENTION

1. Field of the Invention

This invention relates to an ultra-thin keypad, and more particularly, to an ultra-thin keypad for cooperating with the circuit board in a portable electronic device.

2. Description of the Prior Art

With the advance of technology and changes in market demand, the trend of a portable electronic device is developed to be lightweight and compact size. Many manufacturers also tend to make keypads thinner to cope with the trend and satisfy the needs of consumers.

However, most of ultra-thin keypads are made of steel & rubber or polycarbonate (PC) & rubber. Due to the higher cost of material of the ultra-thin keypads and the complexity of manufacturing processes, the costs of related products are also higher.

Accordingly, the objective of the invention is to provide an ultra-thin keypad which is made of one single material by simplified processes and can get the cost down, so as to solve the above-mentioned problem.

### SUMMARY OF THE INVENTION

A scope of the invention is to provide an ultra-thin keypad which is made of polymer materials by injection molding. Therefore, the manufacturing costs is reduced because of the less cost of material and the simple manufacturing processes.

An ultra-thin keypad according to an embodiment of the invention is used for cooperating with the circuit board in a portable electronic device. The circuit board includes a plurality of switches. The ultra-thin keypad includes a main body, a plurality of buttons, and a plurality of thin walls. The buttons are disposed on the main body, and each button corresponds to one of the switches. The thin walls are disposed between adjacent ones of the buttons. When one of the buttons is pressed, the button contacts and activates the corresponding switch by the elastic deformation of the thin walls. The main body, the buttons, and the thin walls are integrally manufactured by pouring a polymer material in a mold and then performing injection molding.

Accordingly, the ultra-thin keypad according to the invention is made of polymer materials by injection molding. So the manufacturing costs can be reduced because of the less cost of material and the simple manufacturing processes.

The advantage and spirit of the invention may be understood by the following recitations together with the appended drawings.

### BRIEF DESCRIPTION OF THE APPENDED DRAWINGS

FIG. 1A is a front view showing an ultra-thin keypad according to an embodiment of the invention.

FIG. 1B is a back view of the ultra-thin keypad of FIG. 1A.

FIG. 2 is a partial cross-sectional view showing an ultra-thin keypad and the circuit board of FIG. 1A.

### DETAILED DESCRIPTION OF THE INVENTION

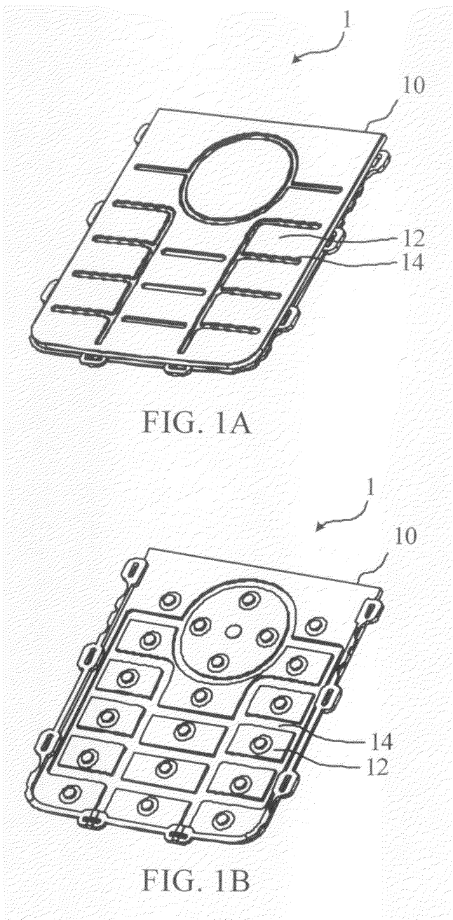

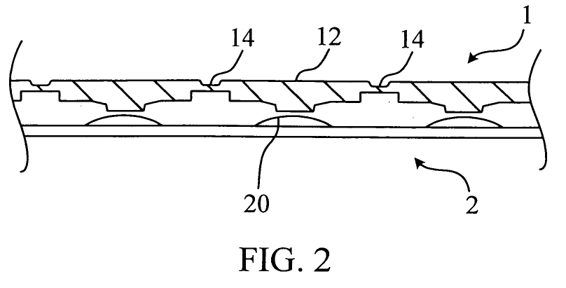

Please refer to FIG. 1A to FIG. 2. FIG. 1A is a front view showing an ultra-thin keypad 1 according to an embodiment of the invention. FIG. 1B is a back view of the ultra-thin keypad 1 of FIG. 1A. FIG. 2 is a partial cross-sectional view showing the ultra-thin keypad 1 and a circuit board 2 of FIG. 1A. In the embodiment, the ultra-thin keypad 1 of the invention is used for cooperating with the circuit board 2 in a portable electronic device (not shown in figures), as shown in FIG. 2. The circuit board 2 includes a plurality of switches 20. In a practical application, the portable electronic device can be, but not limited to, a mobile phone, a PDA (personal digital assistant), or a portable navigation device.

As shown in FIG. 1A and FIG. 1B, the ultra-thin keypad 1 includes a main body 10, a plurality of buttons 12, and a plurality of thin walls 14. The buttons 12 are disposed on the main body 10, and each button 12 corresponds to one of the switches 20, as shown in FIG. 2. The thin walls 14 are disposed between adjacent ones of the buttons 12. When one of the buttons 12 is pressed, the button 12 contacts and activates the corresponding switch by the elastic deformation of the thin walls 14, as shown in FIG. 2. In the embodiment, the switches 20 are, but not limited to, metal domes.

In the embodiment, the main body 10, the buttons 12, and the thin walls 14 of the ultra-thin keypad 1 are integrally manufactured by pouring a polymer material in a mold (not shown in figures) and then performing injection molding. The polymer material can be TPU (thermoplastic polyurethane) or other similar material. In the embodiment, the thicknesses of the thin walls 14 of the ultra-thin keypad 1 are smaller than 0.25 mm. It is notable that ordinary material (such as a combination of steel and rubber, or a combination of polycarbonate and rubber) used to manufacture ultra-thin keypads can be replaced by TPU because TPU has the elasticity similar to rubber.

Compared with prior arts, the ultra-thin keypad of the invention is made of polymer materials by injection molding and is able to be used for cooperating with the circuit board in the portable electronic device. Thus, the manufacturing costs of the keypad of the invention can be reduced because of the less cost of material and the simple manufacturing processes.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A ultra-thin keypad for cooperating with a circuit board in a portable electronic device, the circuit board comprising a plurality of switches, the ultra-thin keypad comprising:
a main body;
a plurality of buttons being disposed on the main body, each button corresponding to one of the switches; and
a plurality of thin walls being disposed between adjacent ones of the buttons, when one of the buttons is pressed, the button contacts and activates the corresponding switch by the elastic deformation of the thin walls;
wherein the main body, the buttons, and the thin walls are integrally manufactured by pouring a polymer material in a mold and then performing injection molding.

2. The ultra-thin keypad of claim 1, wherein the polymer material is TPU (thermoplastic polyurethane).

3. The ultra-thin keypad of claim 1, wherein each switch is a metal dome.

4. The ultra-thin keypad of claim 1, wherein the thicknesses of the thin walls are smaller than 0.25 mm.

5. A portable electronic device comprising:
a circuit board comprising a plurality of switches; and
a ultra-thin keypad for cooperating with the circuit board, the ultra-thin keypad comprising:
a main body;
a plurality of buttons being disposed on the main body, each button corresponding to one of the switches; and
a plurality of thin walls being disposed between adjacent ones of the buttons, when one of the buttons is pressed, the button contacts and activates the corresponding switch by the elastic deformation of the thin walls;
wherein the main body, the buttons, and the thin walls are integrally manufactured by pouring a polymer material in a mold and then performing injection molding.

6. The portable electronic device of claim 5, wherein the polymer material is TPU (thermoplastic polyurethane).

7. The portable electronic device of claim 5, wherein each switch is a metal dome.

8. The portable electronic device of claim 5, wherein the thicknesses of the thin walls are smaller than 0.25 mm.
